(19) United States
(12) Patent Application Publication
(10) Pub. No.: US 2021/0354607 A1
(43) Pub. Date: Nov. 18, 2021

(54) Deep Draw Trim Attachment

(71) Applicant: Irvin Automotive Products, LLC, Pontiac, MI (US)

(72) Inventors: Gregory Lee Ward, Wolverine Lake, MI (US); Steven Michael Zabaroni, Troy, MI (US); Michael Joseph Gregg, Rochester Hills, MI (US)

(73) Assignee: Irvin Automotive Products, LLC, Pontiac, MI (US)

(21) Appl. No.: 16/876,411

(22) Filed: May 18, 2020

(51) Int. Cl. B60N 2/58

(52) U.S. Cl. CPC B60N 2/5833; B60N 2/5875; B60N 2/5891

(57) ABSTRACT

A deep draw trim member for use in a vehicle seat is disclosed. The deep draw trim member comprises a strip of hook material secured to a foam of the vehicle seat, The deep draw trim member also comprises a strip of loop material secured to a seat trim member, wherein the strip of loop material having a plurality of slits arranged throughout. The strip of loop material is engaged with the strip of hook material to create a seating surface that is aesthetically pleasing for the vehicle seat. The seat trim member is applied to the vehicle seat via a pressing of the vehicle seat trim. member to the vehicle seat foam such that the hook and loop materials attached thereto and interengage with one another to create a secure connection therebetween along with an improved and aesthetically pleasing outer surface for the vehicle seat assemblies.

### BACKGROUND OF THE INVENTION

### 1. Field of the Invention

The present invention generally relates to a vehicle seat, and more particularly relates to a deep draw trim attachment used to secure a seat trim cover to a foam pad of a vehicle seat assembly.

### 2. Description of Related Art

Vehicle seats have been known for many years in the prior art. Generally, conventional vehicle seat assemblies include a trim cover, which functions to provide a comfortable seating surface for an occupant, and a foam pad which functions to provide a cushion support for the occupant. Some of these prior art vehicle seat assemblies also may include hook and loop fasteners along the surface of the foam pad to fasten the trim cover to the foam pad. While these prior art materials follow the contour along the surface of the foam pad, generally they do not bend along the surface of the foam pad and hence, do not leave an aesthetically pleasing look for the outer surface of the trim cover of the prior art vehicle seat assemblies. These prior art vehicle seat assemblies after the trim cover is secured to the underlying foam of the vehicle seat had a bridging condition which created a disuniform look to the outer surface of the vehicle seat. Furthermore, other prior art concepts, which may alleviate the bridging problem may have resulted in material break or a creasing appearance which occurs on the outer surface of the trim cover for the seat assembly, thus creating an unacceptable and a not pleasing look for the outer surface of the vehicle seat assembly to the user's of the vehicle. Furthermore, with the connecting material being rigid, such as a hook and loop fastener generally used in the prior art, the bridging and creasing issue was more prevalent in the prior art, which was unacceptable in the prior art seating assemblies.

Therefore, there is a need in the art for an improved deep draw trim attachment for use on a vehicle seat. There also is a need in the art for a deep draw trim attachment which may remove any bridging, material break or creasing appearances on the outer surface of a vehicle seat trim cover. There also is a need in the art for a deep draw trim attachment for use in a vehicle seat assembly that uses a loop material in association with a hook material wherein the loop material has a plurality of slits arranged therein, these slits may greatly improve the appearance and eliminate any break or crease appearances that occur on the outer surface of the vehicle trim cover, specifically at the deep draw trim attachment areas. There is also a need in the art for a deep draw trim attachment mechanism that is easy to produce, easy to use and reduces the cost of the vehicle seat assemblies.

### SUMMARY OF THE INVENTION

One object of the present invention may be to provide an improved vehicle seat assembly.

Another object of the present invention may be to provide a deep draw trim attachment for use in a vehicle seat assembly.

Yet a further object of the present invention may be to provide a vehicle seat assembly having a deep draw trim attachment that uses a strip of hook material secured to a foam with a vehicle seat.

Yet a further object of the present invention may be to provide a deep draw trim attachment that uses a strip of loop material secured to a seat trim member for use as an outer covering of the vehicle seat assembly.

Still another object of the present invention may be to provide a deep draw trim attachment for a vehicle seat assembly that uses a plurality of slits arranged within a strip of loop material which is secured to a seat trim member in order to secure the seat trim member to the underlying foam of the vehicle seat with an aesthetically pleasing and smooth appearance specifically at the deep draw seams arranged thereon.

Still another object of the present invention may be to provide a deep draw trim attachment member for use in a vehicle seat assembly that is low in cost and easy to manufacturer.

According to the present invention, the foregoing and other objects and advantages are obtained by a novel methodology and apparatus for use in a vehicle seat assembly. The apparatus includes a deep draw trim member for use in a vehicle seat comprising a strip of hook material secured to a foam of the vehicle seat. The deep draw trim member also comprises a strip of loop material secured to a seat trim member, wherein the strip of loop material having a plurality of slits arranged therethrough, The deep draw trim member for use in a vehicle seat also comprises the strip of loop material to be engaged with the strip of hook material to create a seating surface with an aesthetically pleasing and smooth appearance for the vehicle seat.

One advantage of the present invention may be that it provides for an improved vehicle seat assembly.

A further advantage of the present invention may be that it provides for an improved vehicle seat assembly through use of a deep draw trim attachment member used to secure a vehicle trim member to the foam of a vehicle seat.

Still another advantage of the present invention may be that it provides for a deep draw trim attachment member that uses a strip of hook material secured to a foam of a vehicle seat.

Still another advantage of the present invention may be that it provides a deep draw trim attachment member for use in a vehicle seat that uses a strip of loop material secured to a seat trim member of the vehicle seat assembly.

Yet another advantage of the present invention may be that it provides a deep draw trim attachment member that uses a strip of loop material having a plurality of slits arranged therethrough.

Still another advantage of the present invention may be that it provides for a deep draw trim attachment member that uses a strip of loop material to engage with a strip of the hook member to create an outer seating surface for a vehicle seat that is aesthetically pleasing and does not have bridging, breaking or creasing appearance issues, such as those of prior art vehicle seat assemblies.

Still another advantage of the present invention may be that it provides a vehicle seat assembly that includes a deep draw trim attachment member that is lower in cost than prior art vehicle seat assemblies, easier to manufacture and assemble into a seat than prior art vehicle seat assemblies.

Other objects, features and advantages of the present invention may become apparent from the subsequent and appended claims, taken in conjunction with the accompanying drawings.

### BRIEF DESCRIPTION OF THE DRAWINGS:

FIG. 1 shows a side view of a vehicle trim member according to the present invention.

FIG. 2 shows a perspective view of a flat stock loop material according to the present invention.

FIG. 3 shows a top view of a loop material according to the present invention.

FIG. 4 shows a top view of a web adhesive for heat transfer lamination according to the present invention.

FIG. 5 shows a finished trim member having the loop material with a plurality of slits laminated to a foam backing according to the present invention.

FIG. 6 shows a top view of a loop material having a plurality of slits arranged therethrough according to the present invention.

FIG. 7 shows a perspective view of a vehicle seat assembly according to the present invention.

FIG. 8 shows a cross sectional view of a deep draw trim attachment member seam of the vehicle seat assembly according to the present invention.

FIG. 9 shows a close up view of area B of FIG. 8.

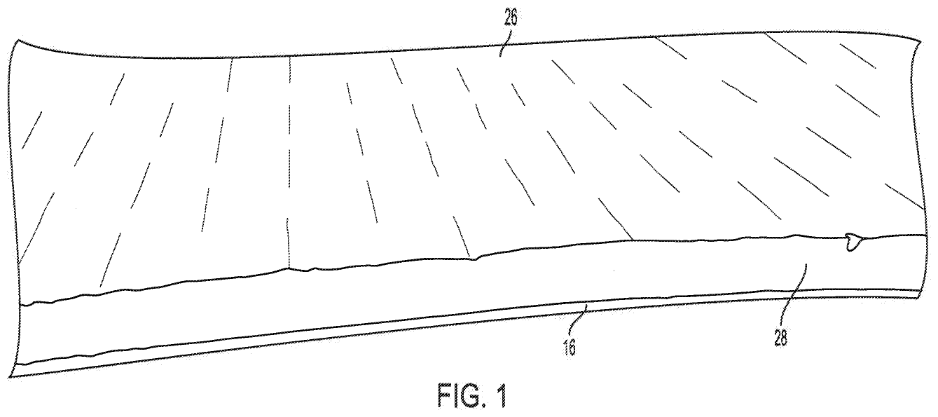

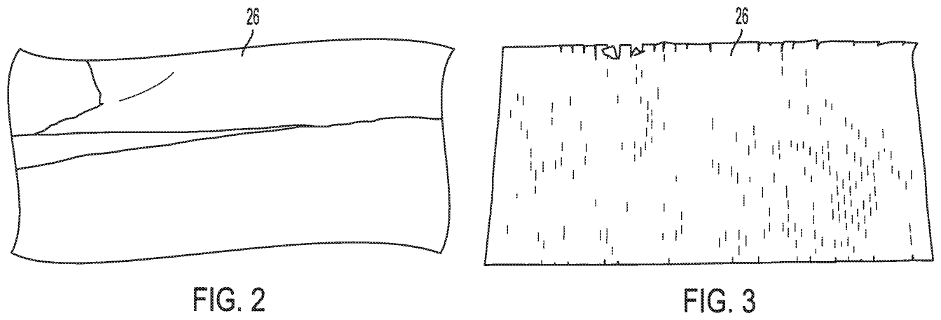

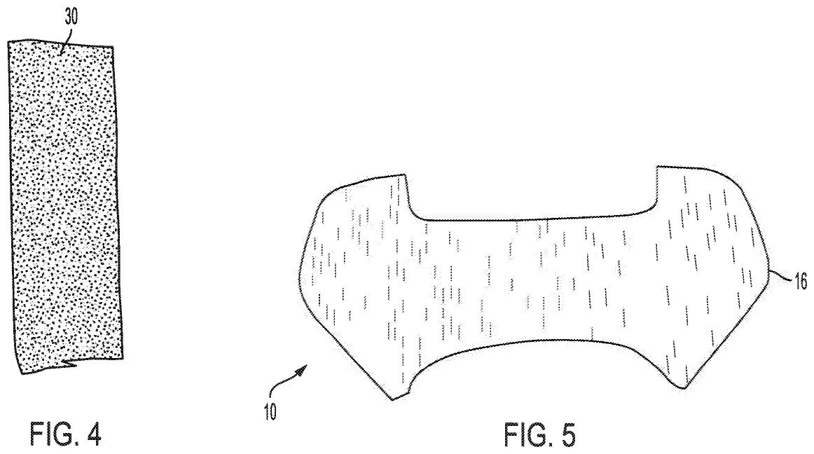

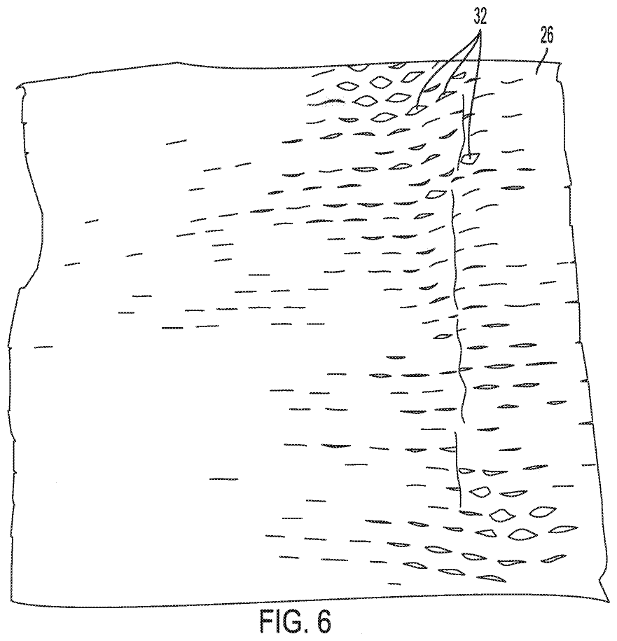

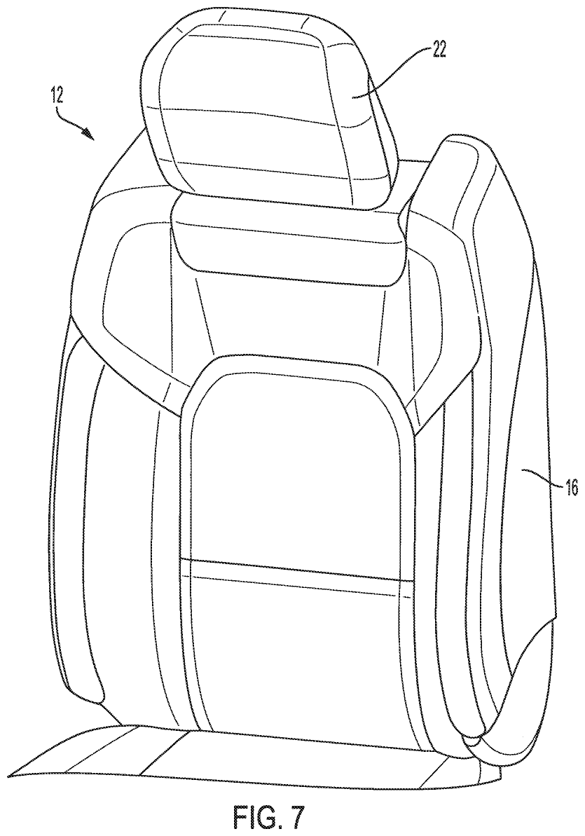

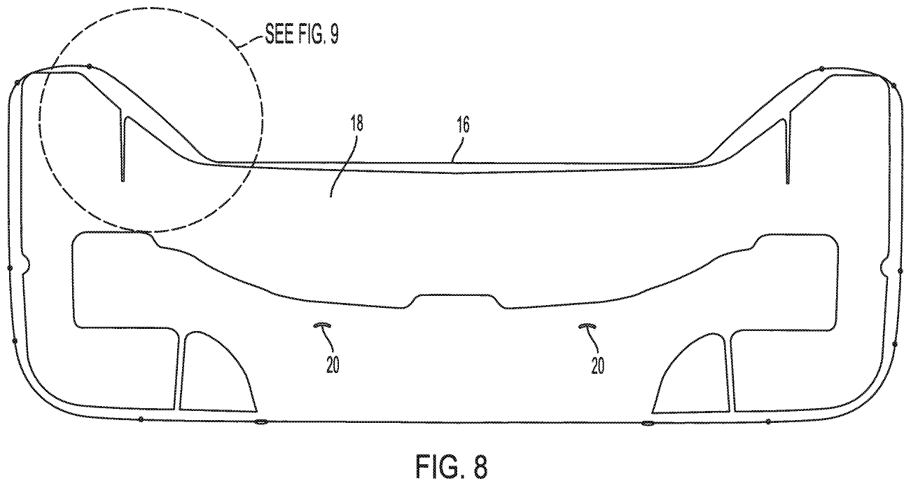

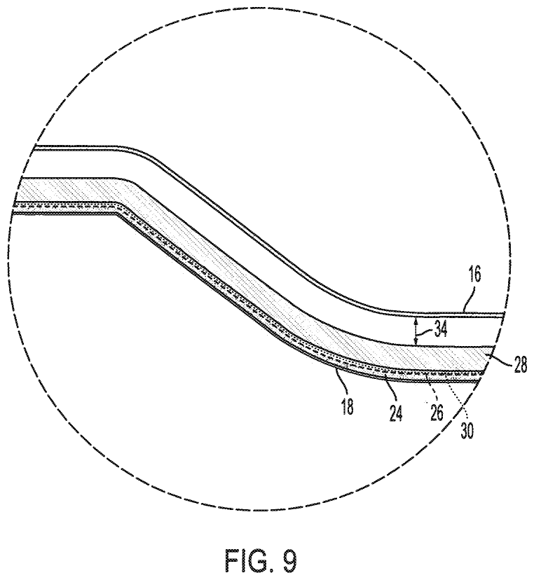

### BRIEF DESCRIPTION OF THE EMBODIMENT(S)

Referring to the drawings, there is shown a deep draw trim attachment member 10 for use in a vehicle seat or vehicle seat assembly 12 according to an embodiment of the present invention. The deep draw trim attachment member 10 of the present invention is for use on a vehicle seat assembly 12. However, it should be noted that the deep draw trim attachment member 10 may be used on any other known device that needs to fasten two devices to one another, such as any other type of vehicle such as an aeronautic vehicle, a marine vehicle, an automotive vehicle, a space vehicle, or even trim cover assemblies within vehicles, such as door panels, floorboards or any other type of system that connects a trim device to an underlying surface, such that the outer surface of the trim cover may have an aesthetically pleasing look to the user of the device. Generally, the vehicle seat assembly 12 is an upholstered seat 12 that may include a flexible seat trim cover or foundation material 16, a foam pad or bun 18, a seat frame 20, a headrest 22 and optional armrest connected to the seat 12. Generally, the seat 12 has a seat back and a seating surface for a user of the vehicle. It should be noted that the vehicle seat frame 20 may have a plurality of mounting brackets and the like to secure the vehicle seat 12 within the vehicle. It should further be noted that the infrastructure of a vehicle seat 12 may include components such as springs, a track assembly, reclining components, and a number of other related components not shown here but commonly known in the seating art. It should be noted that the seat frame 20, seatback and seating surface may be made of any known material with the seat frame 20 generally being made of a metal material such as steel, aluminum, or other metal alloy or other suitable hardened polymer. The seat trim material 16 and seat foam 18, which is arranged over the seat frame 20 to create the outer look and comfort of the seat 12 may be made of any known foam, fabric, plastic, cloth, vinyl, leather, PU, or other soft pliable material that is capable of being formed into a seat shape.

The vehicle seat assembly 12 of the present invention generally includes a seat trim cover or foundation or trim cover 16, a foam pad 18, and a deep draw trim attachment member 10 which is used as a fastening device in order to fasten the seat trim cover 16 to the foam pad 18 of the vehicle seat back or vehicle seating surface. It should be noted that the vehicle seat assembly 12 shown in the drawings is a bucket type vehicle seat assembly, however any other alternative seat, such as a bench type vehicle seat assembly or any other vehicle seat assembly may also be used according to the present invention. It should be noted that the seat trim cover 16 generally provides a comfortable seating surface for an occupant of the vehicle while the foam pad 18 functions to provide a cushion of support for the occupant and each of them are preferably made from conventional materials with conventional methods, but may be made from other suitable materials and other suitable methods depending on the design requirements of the vehicle seat assembly 12. The deep draw trim attachment member 10 which acts as a fastening device and methodology basically secures the vehicle seat trim cover 16 to the foam pad 18 of the vehicle seat 12, which is arranged under the vehicle seat trim cover 16. The deep draw trim attachment member 10 of the present invention may be used on the deep draw areas of a vehicle seat back or seating surface design that may occur between the bolster portion of the vehicle seatback and the center insert, which is arranged within the bolster portion of the vehicle seat insert. In one contemplated embodiment, the bolster generally may have a U-shape and forms the outer region of the vehicle seat back, while the center insert is arranged within the opening formed by the U-shaped bolster and creates a seam between the center insert and the bolster which generally may have a U-shape. However, it should be noted that any other shaped seam may be used for the deep draw trim attachment member 10 according to the present invention. The deep draw trim attachment member 10 is generally used to improve the aesthetic quality of the vehicle seat assembly 12 for the user of the automotive vehicle. It should further be noted that the deep draw trim attachment member 10 of the present invention may also be used on any type of trench or cavity arranged within the seat foam 18 of a vehicle seat back or vehicle seating surface member.

The deep draw trim attachment member 10 of the present invention generally may include a strip or portion of a hook material 24. The hook material 24 may be secured to the foam 18 of the vehicle seat assembly 12 according to the present invention. The hook and loop material generally used in the deep draw trim attachment member 10 of the present invention may be a Velcro material, however any other type of hook and loop material may also be used. It should be noted that the strip of hook material 24 that is directly secured to the seat back foam 18 may be secured via any known chemical or mechanical fastening technique, such as but not limited to glue, epoxy, lamination, etc., or having the hook material 24 directly foamed onto an outer surface of the foam 18 during manufacture of the seat foam 18. The hook and loop material may be made of any known plastic material, fabric or natural material or any other material capable of having a plurality of hooks and loops arranged on opposite piece members, such that when the hook and loop members are pressed into one another they form a tight secure bond between interaction of the loops with the hooks to create a secured connection therebetween. It should be noted that the hook material 24 may have any known length, width or thickness depending on the design requirements. It should also be noted that the hook material 24 may have any known shape other than that of a strip, such as but not limited to any known rectangular, square, triangular, oblong, oval, or any other known shape or any random shape such as that shown in FIG. 5 of the drawings, It should be noted that the hook material 24 and the loop material 26 of the present deep draw trim attachment member 10 may have complimentary shapes, such that if the seat trim cover 16 is secured to the underlying seat foam 18 the hook and loop material 24, 26 may interact with one another to create a secure attachment between the seat foam 18 and the seat trim member 16, thus creating an aesthetically pleasing look for the vehicle seat trim outer surface. It should be noted that the hook material 24 may be secured to the foam 18 at the point of manufacture of the foam 18 or may be secured to the foam 18 at the final vehicle seat assembly 12 location. The strip or portion of hook material 24 is secured to the foam 18 such that the hook material 24 may not release from the foam 18 during use. The hook material 24 may be connected directly during the foam manufacturing process or as an addition to the foam 18 after the foam 18 has been manufactured.

The deep draw trim attachment member 10 according to the present invention may also include a second material in the form of a strip or portion of loop material 26, which is secured to an inner surface of the seat trim member 16. As noted above, the hook material 24 is secured to an outer surface of the foam 18 of the vehicle seat 12 such that the hooks extend from the outer surface of the foam 18 a predetermined distance. The loop material 26 may in turn extend a predetermined distance from an inside surface of the seat trim member 16. It should be noted that the seat trim member 16 may be made of any known material, such as any known leather, pleather, cloth, vinyl, plastic or any other known natural or man made material which creates an aesthetically pleasing and comfortable outer look for a vehicle seat assembly 12 within a vehicle. In one contemplated embodiment, the seat trim member 16 may have the strip of loop material 26 secured directly to the seat trim member 12 such as a leather or fabric as discussed above. However, in another contemplated embodiment, the strip or portion of loop material 26 may be secured to a foam backing material or plus pad 28, which is secured to an inner surface of the outer covering of the seat trim member 16 via a lamination process or any other known securing process. It should be noted that in one contemplated embodiment a lamination 34 is used, but any other known mechanical or chemical fastening technique may be used to secure the foam backing member 28 to the inside surface of the vehicle seat trim cover 16. In the embodiment where a foam backing material 28 is arranged on an inside surface of the seat trim member 16 the strip of loop material 26 is then secured and fastened to the foam backing material 28 via any known fastening technique, such as but not limited to a web adhesive 30 which may be used for heat transfer lamination of the loop material 26 to the foam backing 28 of the vehicle seat trim cover 16. Therefore, in one contemplated embodiment, the loop material 26 is laminated to the foam backing 28 of the seat trim member 16 which has a predetermined pattern. It should be noted that the loop material 26 may be laminated in one contemplated embodiment to the vehicle seat trim member patterns while the hook material 24 may be applied and secured to the outer surface of the vehicle seat foam 18 at a separate location. As noted above, the strip of loop material 26 may have the same general shape as that of the hook material 24 and the shape is dependant on the vehicle seat 12 design and type. As noted above, the deep draw trim attachment member 10 may be used on a seat back or a seating surface of a vehicle seat 12 according to the present invention.

In operation, the vehicle seat trim 16 having the loop material 26 secured to an inside surface thereof may be pressed into the outer surface of the vehicle seat foam 18, which may have the hook material 24 arranged thereon, thus creating a secure connection between the vehicle seat trim member 16 and the vehicle seat foam 18. This may result in an aesthetically pleasing vehicle seat assembly 12 to the buying public. It should be noted that the use of the hook and loop material 24, 26 has been known in the prior art but resulted in bridging, material breaks and creases appearing in the outer finished assembly of the vehicle seat assemblies 12. This bridging and creasing was unacceptable as it ruins the aesthetically pleasing look and feel of the vehicle seats 12 to the operators of the vehicles. The loop material 26 which is secured to the seat trim member 16 also includes a plurality of slits 32 therethrough. The slits 32 are generally arranged in a plurality of lines with a predetermined distance arranged between each line of slits 32. For each line of slits 32 arranged through the loop material 26 there is a predetermined distance or gap between the individual slits 32 of each line of plurality of slits 32 arranged through the loop material 26. It should be noted that the slits 32 are arranged through and along the entire surface area of the loop material 26 and cover all portions of the loop material 26 from the top edge to the bottom edge and from a first side to the second side of the loop material 26 and within any shape of the loop material 26. The slits 32 have a predetermined length and when the loop material 26 is viewed from above a generally grate like appearance is shown. These slits 32 may have a linear or line like shape, however any other shape slit 32, such as circular slits, S-shaped slits, or any other type or design of slit 32 that is capable of being placed through the material formed for the loop material 26 may be used. Therefore, each line of slits 32 is adjacent to another line of slits 32 wherein all of the lines are parallel to each other in the embodiment shown and there is a predetermined gap or distance arranged between each line of the loop material 26. It should further be noted that the slits 32 in a first line of the loop material 26 are offset from a second line thereof, wherein the second line is adjacent to and the immediate next line to the first line. Therefore, in an alternating pattern across the entire width of the loop material 26 may be a plurality of offset slits 32. It should be noted that the pattern of slits 32 in adjacent lines to one another may also include in another contemplated embodiment the slits 32 being directly adjacent and aligned to one another and not offset in successive lines. In one contemplated embodiment, a first line on a first edge of the loop material 26 may have a plurality of slits 32 with a predetermined distance or gap between each slit 32 of that first line and the second line which is directly adjacent to and next to the first line may have a plurality of slits 32 with a predetermined distance or gap therebetween. The predetermined distance between slits 32 may be the same or different. The first line of slits 32 may be offset with respect to the second line of slits 32, such that the slits 32 of the second line and first line may not be across from each other but may be offset such that the predetermined gap of the first line may be where the slits of 32 the second line occur in the second line, Then the third line, which is adjacent to the second line, may have its slits 32 offset from the second line and this pattern may occur throughout the rest of the lines of slits 32 of the loop material 26. It should be noted that any type of cutting tool may be used to place the slits 32 in the predetermined pattern described above or any other known predetermined pattern or it is also contemplated that any known cutting tool or manufacturing technique that may directly mold the slits 32 into the loop material 26 of the hook and loop material 24, 26 may be used. The use of the plurality of slits 32 throughout the entire surface of the loop material 26 creates a greatly improved appearance and elimination of the break or creases of the seat 12. This improved appearance maybe because the loop material 26, with the plurality of slits 32, more easily and uniformly forms to the outer surface shape of the foam 18, thus creating the improved appearance especially at the deep draws where the bolster and the center portion of the seat back meet at a seam.

In application, the ability to secure the seat trim member 16 to the seat foam 18 has been reduced in complexity and has been reduced in the amount of time necessary to create an aesthetically pleasing outer surface for the vehicle seat assembly 12 seating surface and seat back surface with the use of the plurality of slits 32 in the loop material 26 which is secured to the seat trim member inner surface. The manufacturer of the seat 12 only has to align the vehicle seat trim member 16 over the vehicle seat foam 18 of either the seat back or the seating surface and then press the vehicle seat trim member 16 onto the vehicle seat foam 18 such that the loops 26 of the vehicle seat trim member 16 and the loop material 26 having a plurality of slits 32 therein interacts more directly with the hook material 24, which is secured to the outer surface of the seat foam 18, thus allowing for a more complete interengagement between the loop material 26 and the hook material 24, thus creating a uniform and aesthetically pleasing smooth outer surface for the vehicle seat assembly 12. The use of the hook and loop material 24, 26 may also create a secured connection between the seat trim member 16 and the seat foam 18 along with any hooks and straps that are used to secure the seat trim member 16 underneath the vehicle seating surface to create a secure aesthetically pleasing and supportive seat for the user of the vehicle. Therefore, in operation the hook material 24 is secured to the outer surface of the foam 18, either at a remote location or at the location of the final seating assembly via any known lamination or securing technique that involves glue, epoxy, or any other mechanical or chemical fastening technique. The seat trim member 16 is then cut and formed into the appropriate shape to cover the seat back foam 18 and the seating surface foam 18. The vehicle seat trim member 16 may have a foam backing material 28 arranged on an inside surface thereof and a loop material 26 having a plurality of slits 32 therein then laminated to the inside surface of the seat trim member 16, either directly to the outer cover of the seat trim member 16 or to the foam backing material 28 on the inner surface of the seat trim member 16. The loop material 26 is secured to the inside surface of the seat trim member 16, The vehicle seat back and seating surface have foam 18 secured to the seat frame 20. Next a manufacturing employee may align the seat trim member 16 over the foam 18 in a predetermined position and then press either with a tool or with their hand the vehicle seat trim member 16 into and on the outer surface of the vehicle seat foam 18 thus int rengaging the hook material 24 and the loop material 26 in order to secure to the foam 18 to the seat trim member 16. This creates a secured interconnection and interengagement between the seat trim member 16 and the seat foam 18. This interengagement also occurs in the deep draw areas where a vehicle seat bolster and center insert may come in contact with one another in an adjacent manner. This method of securing the seat trim member 16 with the deep draw trim attachment member 10 to the vehicle seat foam 18 reduces manufacturing time and creates a more improved outer appearance for the vehicle seat assembly 12. As noted above, the deep draw trim attachment member 10 may be used on any known vehicle seat or any known seat other than that of vehicles.

The present invention has been described in an illustrative manner. It is to be understood that the terminology, which has been used is intended to be in the nature of words of description rather than that of limitation.

Many modifications and variations of the present invention are possible in light of the above teachings. Therefore, within the scope of the appended claims, the present invention may be practiced otherwise than what is specifically described.

What is claimed is:

1. A deep draw trim member for use in a vehicle seat, said deep draw trim member comprising:
a strip of hook material secured to a foam of the vehicle seat;
a strip of loop material secured to a seat trim member;
said strip of loop material having a plurality of slits arranged therethrough; and
said strip of loop material engaged with said strip of hook material to create a seating surface for said vehicle seat.

2. The deep draw trim member of claim 1 wherein said hook material is secured to said foam via a chemical fastening methodology.

3. The deep draw trim member of claim 1 wherein said loop material is laminated to an inside surface of said seat trim member.

4. The deep draw trim member of claim 1 wherein said loop material plurality of slits are arranged in a plurality of lines.

5. The deep draw trim member of claim 4 wherein said plurality of lines are parallel to one another.

6. The deep draw trim member of claim 5 wherein said plurality of slits having a predetermined distance between each slit in each of said line.

7. The deep draw trim member of claim 6 wherein said plurality of lines having a predetermined gap arranged therebetween.

8. The deep draw trim member of claim 7 wherein said plurality of slits in a first line are offset from said plurality of slits of an adjacent second line.

9. The deep draw trim member of claim 1 wherein said plurality of slits are arranged over an entire surface of said loop material.

10. The deep draw trim member of claim 3 wherein a web adhesive is used to laminate the loop material to a foam backing material.

11. The deep draw trim member of claim 1 wherein said seat trim member having a layer of foam backing arranged on an inside surface thereof.

12. The deep draw trim member of claim 1 wherein said hook material is thin.

13. A method of covering a vehicle seat with a trim member, said method comprising the steps of:
securing a strip of hook material to a foam of the vehicle seat;
securing a strip of loop material to the trim member, said loop material having a plurality of slits therethrough;
aligning said strip of hook material with said strip of loop material; and
pressing said strip of loop material into said strip of hook material to finish the vehicle seat, creating an aesthetically pleasing deep draw along a seam thereof.

14. The method of claim 13 further comprising the step of laminating said loop material to the trim member.

15. The method of claim 13 wherein said plurality of slits are arranged in a plurality of lines,

16. The method of claim 15 wherein said plurality of lines are parallel to one another.

17. The method of claim 15 wherein said plurality of slits having a predetermined distance between each said slit in each of said lines.

18. The method of claim 15 wherein said plurality of lines having a predetermined sized gap arranged between adjacent lines.

19. The method of claim 15 wherein said plurality of slits in a first line are offset from said plurality of slits of an adjacent second line.

20. The method of claim 13 wherein said loop material is laminated to the trim member with a web adhesive.
